(19) United States
(12) Patent Application Publication
(10) Pub. No.: US 2026/0229712 A1
(43) Pub. Date: Aug. 6, 2026

(54) BATTERY PACKAGE AND BATTERY MODULE

(71) Applicant: KYOCERA Corporation, Kyoto-shi, Kyoto (JP)

(72) Inventor: Koutarou NAKAMOTO, Kyoto-shi (JP)

(73) Assignee: KYOCERA Corporation, Kyoto-shi, Kyoto (JP)

(21) Appl. No.: 19/147,104

(22) PCT Filed: Jan. 9, 2024
(86) PCT No.: PCT/JP2024/000119

§ 371 Date: Jul. 10, 2025

(30) Foreign Application Priority Data
Jan. 11, 2023 (JP) 2023-002491

(51) Int. Cl. H01M 50/503; H01M 50/109; H01M 50/202; H01M 50/271; H01M 50/522

(52) U.S. Cl. CPC H01M 50/503; H01M 50/109; H01M 50/202; H01M 50/271; H01M 50/522

(57) ABSTRACT

To provide a battery module which is not electrically connected to an outside except for an external electrode. The battery module includes a battery and a package. The battery has at least one protrusion. The package includes a restriction portion that comes into contact with the at least one protrusion of the battery to restrict the battery from moving in a direction away from the bottom surface of the first recessed portion due to an elastic force of the elastic member.

### TECHNICAL FIELD

The present disclosure relates to a battery module.

### BACKGROUND OF INVENTION

Various forms of power supplies that can be surface mounted on a mounting substrate together with electronic circuit components have been proposed as power supplies or auxiliary power supplies for small electronic devices.

Patent Document 1 discloses an electrochemical cell in which an electrochemical element is accommodated in an accommodation space of a sealed container. The sealed container has a base member on which a first current collector is formed and a lid member which is fixed to the base member and on which a second current collector is formed, and an accommodation space is defined between both members. The electrochemical element has a first electrode (lower electrode) and a second electrode (upper electrode). An elastic member that presses the second electrode toward the first electrode and electrically connects the second electrode and the second current collector is disposed between the lid member and the second electrode in the accommodation space.

### CITATION LIST

### PATENT LITERATURE

Patent Document 1: JP 2012-069508 A

### SUMMARY

A battery module according to one aspect of the present disclosure includes: a battery including upper and lower electrodes and at least one protrusion; and a package including: an insulating substrate including a first surface, a second surface located on a side opposite to the first surface, and a first recessed portion that opens to the first surface and is configured to accommodate the battery; a first external electrode located on the second surface; a second external electrode located on the second surface; a first electrode located on a bottom surface of the first recessed portion and electrically connected to the battery and the first external electrode; a second electrode electrically connected to the battery and the second external electrode; an elastic member disposed on the first electrode and configured to electrically connect the battery and the first electrode; and a package including a restriction portion configured to come into contact with the at least one protrusion to restrict the battery from moving in a direction away from the bottom surface of the first recessed portion due to an elastic force of the elastic member.

### BRIEF DESCRIPTION OF THE DRAWINGS

FIG. 1 is a perspective view illustrating an external appearance of an exemplary battery module according to Embodiment1.

FIG. 2 is an exploded perspective view of the battery module.

FIG. 3 is an exemplary bottom view of the battery module.

FIG. 4 is a top view of the battery module with a lid body removed.

FIG. 5 is a cross-sectional view taken along line V-V in FIG. 4.

FIG. 6 is a cross-sectional view illustrating an example of an internal structure of the battery according to Embodiment 1.

FIG. 7 is a cross-sectional view of a battery module according to a variation of the above-described battery module.

FIG. 8 is a cross-sectional view illustrating a variation of the battery.

FIG. 9 is a top view of a battery module, which is a variation of the above-described battery module, in a state where a lid body is removed.

FIG. 10 is a cross-sectional view taken along line X-X in FIG. 9.

FIG. 11 is a top view of the exemplary battery module according to Embodiment 1 in a state where the lid body is removed.

FIG. 12 is a cross-sectional view taken along line XII-XII in FIG. 11.

FIG. 13 is a cross-sectional view taken along line XIII-XIII in FIG. 11.

FIG. 14 is a cross-sectional view of a battery module that is a variation of the above-described battery module.

FIG. 15 is a cross-sectional view of an exemplary battery module according to Embodiment 3.

FIG. 16 is a cross-sectional view of a battery module that is a variation of the above-described battery module.

FIG. 17 is a cross-sectional view of an exemplary battery module according to Embodiment 4.

FIG. 18 is a cross-sectional view of a battery module that is a variation example of the battery module.

FIG. 19 is a cross-sectional view of a battery module that is a variation of the above-described battery module.

FIG. 20 is a top view of the exemplary battery module according to Embodiment 5 in a state where the lid body is removed.

FIG. 21 is a cross-sectional view taken along line XXII-XXII in FIG. 20.

FIG. 22 is a diagram illustrating a state in which the battery according to Embodiment 5 is accommodated in a battery package.

FIG. 23 is a top view of the exemplary battery module according to Embodiment 6 in a state where the lid body is removed.

FIG. 24 is a cross-sectional view taken along line XXIV-XXIV in FIG. 23.

FIG. 25 is a diagram illustrating a state in which the battery according to Embodiment 6 is accommodated in a battery package.

FIG. 26 is a cross-sectional view of an exemplary battery module according to Embodiment 7.

### DESCRIPTION OF EMBODIMENTS

In the electrochemical cell disclosed in Patent Document 1, since the upper electrode of the electrochemical element is electrically connected to the lid member via the elastic member between the lid member and the second electrode, the lid member is electrically connected to the outside.

The present disclosure provides a battery module that is not electrically connected to the outside except for an external electrode.

According to one aspect of the present disclosure, a battery module that is not electrically connected to the outside except for the external electrode can be realized.

A battery, a battery package, and a battery module according to embodiments of the present disclosure will be described with reference to the accompanying drawings. In the following description, a lid body side or a first surface side of an insulating substrate in the battery package may be described as an upper side, and an insulating substrate side or a second surface side of the insulating substrate in the battery package may be described as a lower side. A vertical direction may be described as a height direction (thickness direction). This distinction between up and down is merely for the sake of convenience, and does not limit up and down when the battery module or the like is actually used.

### First Embodiment

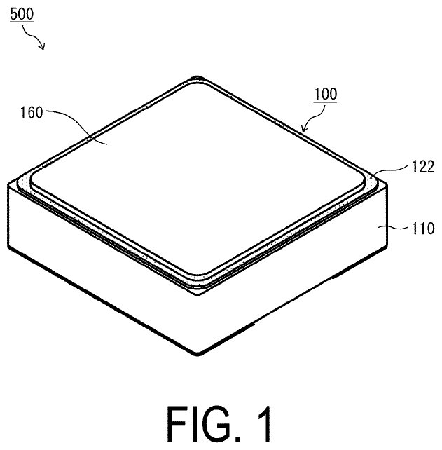

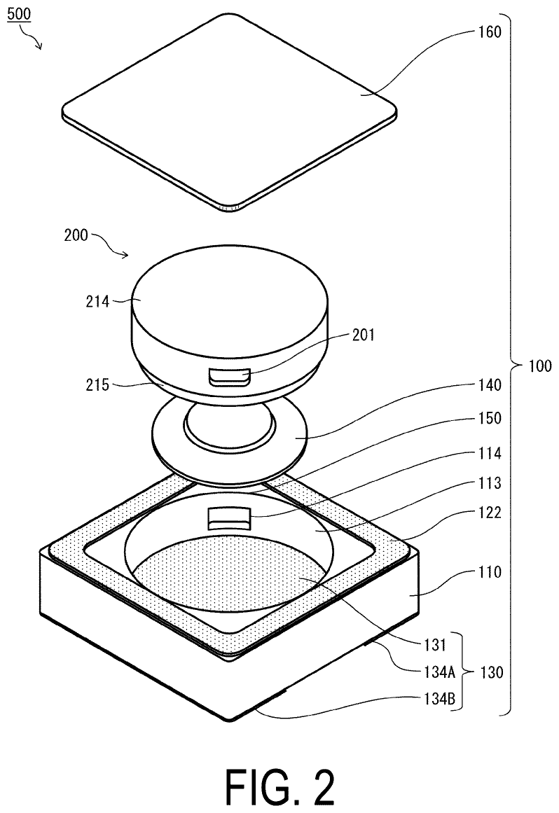

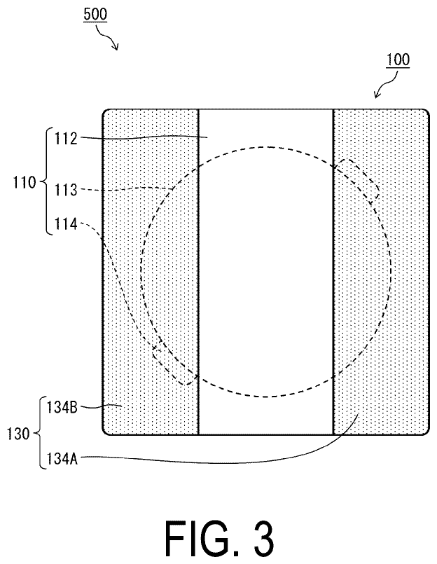

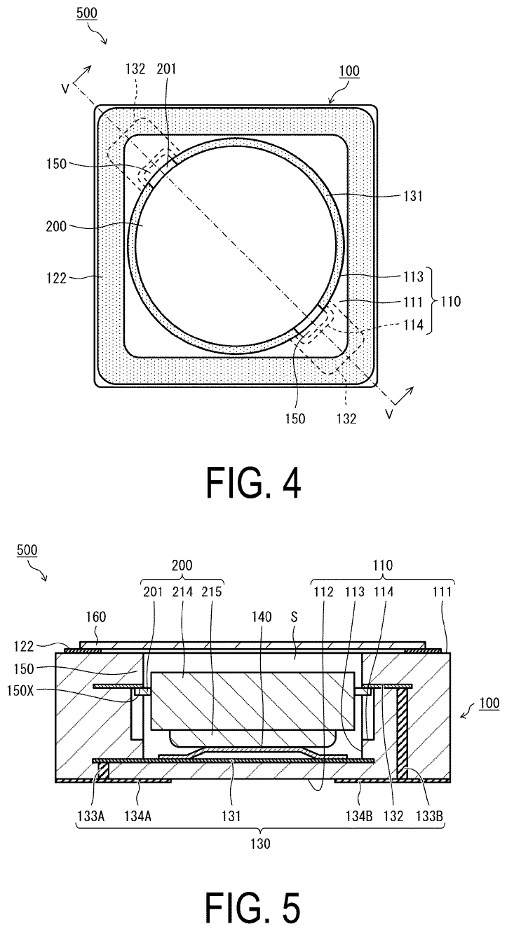

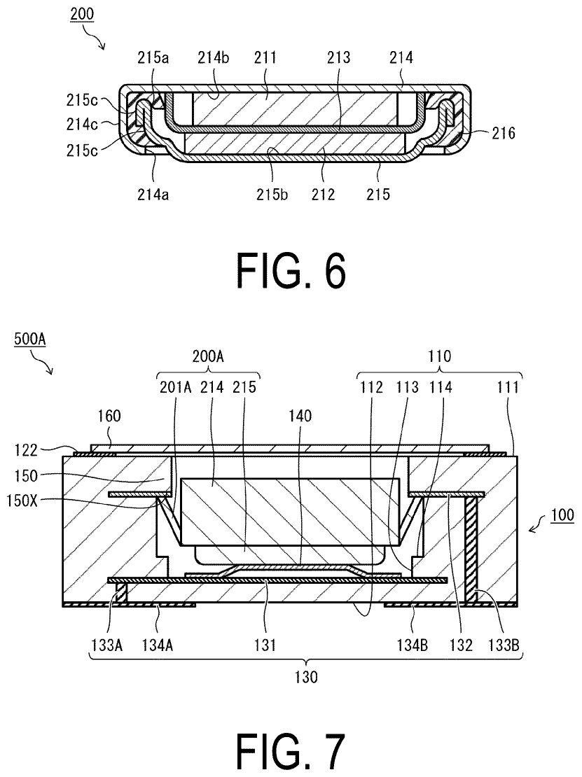

FIG. 1 is a perspective view illustrating an exemplary external appearance of a battery module 500 according to Embodiment 1. FIG. 2 is an exploded perspective view of the battery module 500 in FIG. 1. FIG. 3 is an exemplary bottom view of the battery module 500 in FIG. 1. FIG. 4 is a top view of the battery module 500 with a lid body 160 removed. FIG. 5 is a cross-sectional view taken along line V-V in FIG. 4. FIG. 6 is a diagram illustrating an example of an internal structure of a battery 200. In FIG. 5, the internal structure of the battery 200 is not illustrated. In FIG. 6, a protrusion 201 located at a side surface 214c is not illustrated.

As illustrated in FIGS. 1 to 5, the battery module 500 includes a battery package 100 and one or more batteries 200 accommodated in a first recessed portion 113 of the battery package 100.

### Battery Package

The battery package 100 may include an insulating substrate 110, a conductive elastic member 140, a restriction portion 150, and the lid body 160. The restriction portion 150 is a portion that comes into contact with the protrusion 201 of the battery 200 to restrict the battery 200 from moving in a direction away from the bottom surface of the first recessed portion 113 of the insulating substrate 110 due to the elastic force of the elastic member 140.

The insulating substrate 110 has a first surface 111 and a second surface 112 opposite to the first surface 111. The insulating substrate 110 has the first recessed portion 113 which is open to the first surface 111 and a second recessed portion 114 which is open to an inner side surface of the first recessed portion 113. In the battery module 500 of the present embodiment, one battery 200 is accommodated in the first recessed portion 113. A plurality of batteries may be accommodated in the first recessed portion 113.

The insulating substrate 110 may be made of an insulating inorganic material. The insulating inorganic material is a ceramic such as an aluminum oxide sintered body (an alumina ceramic), an aluminum nitride sintered body, a mullite sintered body, a glass-ceramic sintered body, or the like. When the insulating substrate 110 is a ceramic, the battery 200 can be hermetically sealed, so that the battery 200 can be protected from humidity or oxygen in the external environment. The insulating substrate 110 may include a plurality of layered insulating layers or a single insulating layer. The insulating layer is made of an insulating material such as an aluminum oxide sintered body, a glass ceramic sintered body, a mullite sintered body, or an aluminum nitride sintered body.

When the insulating layer is made of, for example, an aluminum oxide sintered body, the insulating substrate 110 is produced in the following manner. That is, first, ceramic green sheets to be insulating layers are produced. A plurality of quadrangular sheet-shaped ceramic green sheets are produced by forming a raw material powder of aluminum oxide, silicon oxide, and the like into a sheet shape together with an appropriate organic binder and organic solvent. Subsequently, a layered body is produced by layering these ceramic green sheets. The first recessed portion 113 and the second recessed portion 114 are formed by providing through holes in a ceramic green sheet using a mold or the like. Subsequently, the layered body is fired at a temperature of 1300 to 1600° C. to produce the insulating substrate 110.

Regarding the dimensions of the insulating substrate 110, for example, the length of one side of the quadrangle is 1 mm to 20 mm, and the thickness of the insulating substrate 110 is 0.3 mm to 5 mm. The dimensions of the first recessed portion 113 of the insulating substrate 110 may be set according to the size of the battery 200.

As illustrated in FIG. 4, the size of the first recessed portion 113 in plan view is slightly larger than the size of the battery 200 in plan view. The inner wall surface of the first recessed portion 113 may be parallel to the thickness direction of the insulating substrate 110. The depth of the first recessed portion 113 is a depth such that the battery 200 does not come into contact with the lid body 160 in a state where the battery 200 is mounted on the battery package 100. The state in which the battery 200 is mounted on the battery package 100 is a state in which the protrusion 201 abuts against the restriction portion 150 and the elastic member 140 is compressed. The depth of the first recessed portion 113 may be greater than the height of the stack of the battery 200 accommodated in first recessed portion 113 and the elastic member 140 in the uncompressed state. The shape of the first recessed portion 113 in plan view is not limited to a circle, and can be changed in accordance with the shape of the battery 200. In the present specification, the description of “parallel” is intended to mean parallel at a visible level, and does not require being strictly parallel.

As illustrated in FIGS. 2 to 5, the insulating substrate 110 has the second recessed portion 114 that opens on the inner side surface of the first recessed portion 113. Specifically, as illustrated in FIGS. 2 to 5, the insulating substrate 110 may include two second recessed portions 114. The two second recessed portions 114 may face each other with the first recessed portion 113 interposed therebetween. The number of second recessed portions 114 is not limited to two, and a plurality of second recessed portions 114 may be formed along the inner periphery of the first recessed portion 113. Alternatively, the second recessed portion 114 may be a single recessed portion formed over the entire inner periphery of the first recessed portion 113. In other words, the second recessed portion 114 may be a groove formed over the inner periphery of the first recessed portion 113. The number and shape of the second recessed portions 114 may be determined according to the number and shape of the protrusion 201, the arrangement position of the protrusion 201 with respect to the side surface 214c, and the like.

In the present embodiment, as illustrated in FIGS. 4 and 5, the insulating substrate 110 includes two restriction portions 150. The two restriction portions 150 face each other with the first recessed portion 113 interposed therebetween. The two restriction portions 150 are located at opposite corners of the insulating substrate 110. Since the restriction portions 150 are disposed at positions facing each other across the first recessed portion 113, the posture of the battery 200 can be stabilized. Since the restriction portion 150 is located at the corner portion of the insulating substrate 110, a region in which the restriction portion 150 is provided can be secured and the size of the battery module 500 can be further reduced while reducing the likelihood of a decrease in the strength of the insulating substrate 110.

In the present embodiment, the restriction portion 150 is a portion of the insulating substrate 110 located above the second recessed portion 114. The restriction portion 150 has a locking surface 150X facing the second surface 112. The locking surface 150X can also be said to be the upper surface (top) of the second recessed portion 114. Alternatively, the restriction portion 150 may be a protruding portion that protrudes from the inner wall surface of the first recessed portion 113 toward the center of the first recessed portion 113.

Since the battery package 100 includes the restriction portion 150, the battery 200 is restricted from moving in a direction away from the bottom surface of the first recessed portion 113 by the elastic force of the elastic member 140. In other words, the protrusion 201 of the battery 200 is pressed against the restriction portion 150 by the elastic member 140. As a result, the battery 200 is fixed in a state of being pressed against the restriction portion 150. The elastic member 140 can absorb manufacturing errors such as a variation in a height of the battery 200 and a variation in depth of the first recessed portion 113, an expansion and contraction of the battery 200, and the like. The elastic member 140 can alleviate impact when the battery module 500 is assembled.

As illustrated in FIG. 5, the battery package 100 includes a wiring conductor 130 on the surface of and inside the insulating substrate 110. The wiring conductor 130 includes a first electrode 131, a second electrode 132, a first connection wiring 133A, a second connection wiring 133B, a first external electrode 134A, and a second external electrode 134B.

The first electrode 131 is an electrode located on the bottom surface of the first recessed portion 113 and electrically connected to the first external electrode 134A by the first connection wiring 133A. The first electrode 131 may cover the entire bottom surface of the first recessed portion 113. As illustrated in FIG. 5, the first electrode 131 may extend from the bottom surface of the first recessed portion 113 to the inside of the insulating substrate 110. In the case where the first electrode 131 extends to the inside of the insulating substrate 110, the first connection wiring 133A is located in a thick portion of the insulating substrate 110, which is advantageous in terms of the bonding strength with the insulating substrate 110. The first electrode 131 may be accommodated within the bottom surface of the first recessed portion 113 in plan view. That is, the first electrode 131 need not extend to the inside of the insulating substrate 110, and the first connection wiring 133A may penetrate from the bottom surface of the first recessed portion 113 to the second surface 112 and may be connected to the first external electrode 134A. In this case, the path from the battery 200 to the first external electrode 134A is short and has a lower resistance, so that the power is efficiently extracted from the battery 200 accommodated in the first recessed portion 113.

The second electrode 132 is located on the insulating substrate 110 and is electrically connected to the second external electrode 134B by the second connection wiring 133B. In the present embodiment, the second electrode 132 is located at the locking surface 150X of the restriction portion 150. The second electrode 132 may extend from the locking surface 150X of the restriction portion 150 to the inside of the insulating substrate 110. The second electrode 132 may cover the entire locking surface 150X of the restriction portion 150. The second electrode 132 may also be located on the bottom surface of the second recessed portion 114. In the present embodiment, as illustrated in FIGS. 4 and 5, in the insulating substrate 110, the second electrode 132 is located at the locking surface 150X of the two restriction portions 150. By providing the plurality of second electrodes 132 in this manner, even when a connection failure occurs in one of the second electrodes 132, the connection can be secured in the other second electrode 132, so that the reliability of the electrical connection can be improved.

The first external electrode 134A and the second external electrode 134B are located on the second surface 112 of the insulating substrate 110. The first external electrode 134A and the second external electrode 134B may extend from the second surface 112 of the insulating substrate 110 to side surfaces (also including a corner between the side surfaces).

Since both the first external electrode 134A and the second external electrode 134B are located on the second surface 112 of the insulating substrate 110, the battery module 500 can be surface-mounted on a mounting substrate.

The elastic member 140 is a member having elasticity and conductivity, and may be, for example, a plate spring or a disc spring that is convex in a direction away from the bottom surface of the first recessed portion 113 as illustrated in FIGS. 2 and 5. The elastic member 140 is located on the first electrode 131, and is located between the first electrode 131 and the battery 200 when one or more batteries 200 are accommodated in the first recessed portion 113. As a result, the first electrode 131 and the battery 200 are electrically connected via the elastic member 140. When the battery 200 is accommodated in the first recessed portion 113, the elastic member 140 urges the battery 200 in a direction in which the battery 200 moves away from the bottom surface of the first recessed portion 113.

The lid body 160 may close the opening of the first recessed portion 113. The lid body 160 may be, for example, a ceramic or a metal. The lid body 160 is electrically insulated from the first electrode 131 and the second electrode 132. The lid body 160 and the insulating substrate 110 may be bonded by solder bonding, brazing bonding, frit glass, or resin. In this case, the bonding is performed by overall heating by reflow heating. In the case of solder bonding or brazing bonding, as illustrated in FIG. 5, the frame-shaped metal film 122 may be located on the first surface 111, and the lid body 160 may be bonded onto the frame-shaped metal film 122. The frame-shaped metal film 122 may be formed on the first surface 111 by metallization. When the lid body 160 made of a ceramic and the frame-shaped metal film 122 are bonded to each other with a brazing material, a metal film having the same configuration as that of the frame-shaped metal film 122 may also be located on the lower surface of the lid body 160. A nickel film may be formed on the surfaces of the frame-shaped metal film 122 and the lid body 160 by a plating method in order to improve the bonding property of the bonding by the brazing material.

When the lid body 160 made of a metal and the frame-shaped metal film 122 are bonded to each other, direct seam welding, laser welding, or electron beam welding may be used. Since these welding methods are bonding by local heating to the bonding portion, hermetic sealing or vacuum sealing can be performed at a low temperature as compared with bonding by overall heating (reflow heating). By sealing at a low temperature, the influence of heat on the battery 200 is reduced, so that a low dew-point airtight environment or a low dew-point vacuum environment can be implemented. When the lid body 160 is made of a metal, an iron-nickel (Fe—Ni) alloy or an iron-nickel-cobalt (Fe—Ni—Co) alloy may be used as the material of the lid body 160. Since these alloys have a small difference in thermal expansion from ceramics, they are suitable for the lid body 160 of the insulating substrate 110.

By closing the opening of the first recessed portion 113 with the lid body 160, the space surrounded by the lid body 160 and the insulating substrate 110, that is, the accommodation space of the battery 200 can be hermetically sealed or vacuum-sealed.

A space S illustrated in FIG. 5 is a remaining space after the battery 200 is mounted in the accommodation space. The ratio of the volume of the space S to the outer volume of the battery module 500 may be set to, for example, 5% to 30%. The interval between the lower surface of the lid body 160 and the upper surface of the battery 200 may be, for example, 0.1 mm to 0.8 mm. By setting the space S or the distance as described above, in a case where the battery 200 expands due to a high temperature, a case where gas is generated, or the like, an increase in internal stress or internal pressure of the battery 200 is alleviated, and the durability of the battery 200 is improved. Even when a stress is applied to the lid body 160 from the outside, the stress applied to the battery 200 is reduced by the space S between the lid body 160 and the battery 200. Furthermore, since the lid body 160 and the upper surface of the battery 200 are not in contact with each other, and there is no discharge from members other than the external electrodes, such as the lid body 160, to the outside, electric power can be efficiently extracted from the battery 200 via the first external electrode 134A and the second external electrode 134B.

For example, the space S may be sealed in a nitrogen atmosphere or an argon gas atmosphere having a dew point of −20° C. or less, or in an atmosphere such as a vacuum. In this case, even though the environmental temperature and the humidity increase, a chemical reaction between moisture or oxygen and battery materials is suppressed, so that the heat resistance and the life of the battery 200 are improved.

### Battery

The battery according to the present disclosure is a battery having upper and lower electrodes. For example, the battery may be a coin battery in which battery materials such as an electrolyte material, a positive electrode, a negative electrode, and a separator are disposed in a metal container and sealed. The electrolyte material may be, for example, a solid electrolyte. A coin battery may also be referred to as a button battery. The battery according to the present disclosure may be a primary battery or a secondary battery. The battery according to the present disclosure may include not only a chemical battery but also a power supply element such as an electric double layer capacitor.

The battery 200 according to the present embodiment is a coin battery. For example, as illustrated in FIGS. 5 and 6, the battery 200 includes a positive electrode 211, a negative electrode 212, a positive electrode can 214, a negative electrode can 215, and a gasket 216. A separator 213 that holds an electrolyte material and reduces the occurrence of a short circuit between the positive electrode 211 and the negative electrode 212 is located between the positive electrode 211 and the negative electrode 212.

The positive electrode can 214 is a container that accommodates the positive electrode 211. The positive electrode can 214 may be a cylindrical vessel having an opening portion 214a and a bottom 214b. The negative electrode can 215 is a container that accommodates the negative electrode 212. The negative electrode can 215 may be a cylindrical (hat-shaped) vessel having an opening portion 215a and a bottom 215b.

In the present embodiment, the size of the positive electrode can 214 in plan view is slightly larger than that of the negative electrode can 215 in plan view. Therefore, the negative electrode can 215 is inserted into the positive electrode can 214 through the opening portion 214a. The battery 200 has a shape in which the bottom 215b protrudes from the opening portion 214a and a protruding portion is provided on the negative electrode can 215 side. When the positive electrode can 214 is used as an upper electrode, the negative electrode can is a lower electrode, and when the negative electrode can 215 is used as an upper electrode, the positive electrode can 214 is a lower electrode.

The positive electrode can 214 and the negative electrode can 215 are fixed to each other via the gasket 216 located over the entire space between the inner side surface of the positive electrode can 214 and the side surface 215c of the negative electrode can 215 in a state where the positive electrode 211, the negative electrode 212, and the separator 213 are accommodated therein. The inner peripheral surface of the positive electrode can 214 refers to a surface opposite to the side surface 214c of the positive electrode can 214. By being fixed in this manner, the positive electrode 211, the negative electrode 212, and the separator 213 are sealed in a metal container constituted by the positive electrode can 214 and the negative electrode can 215.

As the positive electrode can 214, for example, a metal such as stainless steel or cold rolled steel may be used. A nickel layer may be formed on the surface of the positive electrode can 214 by plating or pressure welding. As the negative electrode can 215, for example, a metal such as a clad material in which copper, nickel, or the like is pressure-welded to stainless steel may be used.

As illustrated in FIGS. 2 to 5, the battery 200 may have at least one protrusion 201 on the side surface 214c. The protrusion 201 protrudes laterally from the battery 200. The protrusion 201 may be a member having conductivity. The protrusion 201 may be integrally molded with the positive electrode can 214. Alternatively, the protrusion 201 may be brazed, soldered, or metal-welded to the side surface 214c of the formed cathode positive electrode can 214. Even when the protrusion 201 is bonded to the positive electrode can 214, the material of the protrusion 201 may be the same as the material of the positive electrode can 214. Other examples of the material of the protrusion 201 include materials generally used for metal springs. The material may be, for example, a hard steel wire or a piano wire, in addition to the stainless steel described above.

The positive electrode can 214 has, on the side surface 214c, the protrusion 201 at a position that comes into contact with at least a part of a restriction portion 150 to be described later in a state where the battery 200 is accommodated in the first recessed portion 113. The positive electrode can 214 may have only one protrusion 201 or a plurality of the protrusions 201 on the side surface 214c. In the present embodiment, the positive electrode can 214 has two protrusions 201 at positions facing each other on the side surface 214c. The positive electrode can 214 may have one annular protrusion 201 along the circumferential direction of the side surface 214c. The positive electrode can 214 may have three or more protrusions 201 located at equal intervals along the circumferential direction of the side surface 214c. In the case of these configurations, in a state where the battery 200 is mounted on the battery package 100, the battery 200 is not inclined, and the battery 200 can be stably fixed to the battery package 100. The likelihood that the battery 200 comes into contact with the lid body 160 due to inclination or movement of the battery 200 can be reduced.

In a state where the battery 200 is accommodated in the first recessed portion 113, the protrusion 201 is in contact with at least a part of the restriction portion 150. In the contact portion, the second electrode 132 may be located between the protrusion 201 and the restriction portion 150. Accordingly, movement of the battery 200 in a direction away from the bottom surface of the first recessed portion 113 is restricted by the elastic force of the elastic member 140. The number, size, and shape of the protrusion 201 and the position of the protrusion 201 on the side surface 214c may be determined in consideration of the ease and cost of manufacturing the protrusion 201, the resistance to the restriction of the movement, and the like.

In the present embodiment, the protrusion 201 has conductivity, and thus is electrically connected to the second electrode 132 in a state of being accommodated in the first recessed portion 113. The number, the size, shape, and position of the protrusion 201 may be determined in consideration of the electrical connection with the second electrode 132 as well as the number, size, shape, and position of the protrusion 201. That is, the number, size, shape, and position of the protrusion 201 may be determined so as to reduce the likelihood that the battery 200 is inclined and a conduction failure occurs in a state where the battery 200 is accommodated in the first recessed portion 113.

The cross-sectional shape of the protrusion 201 along the radial direction of the battery 200 may be a shape in which the length along the radial direction of the battery 200 increases from the negative electrode can 215 side toward the positive electrode can 214 side. In the present embodiment, the cross-sectional shape of the protrusion 201 is a right-angled triangle. The battery 200 is inserted into the first recessed portion 113 from the negative electrode can 215 side. Therefore, when the cross-sectional shape of the protrusion 201 is the above-described shape, the likelihood that the battery 200 can be smoothly inserted into first recessed portion 113 can be increased. Therefore, the shape of the protrusion 201 may be determined in consideration of the ease of insertion into the first recessed portion 113. The shape of the cross section is not limited to a right triangular shape, and may be, for example, a trapezoidal shape, a stepped shape, or an arc shape. The shape of the cross section may be, for example, a rectangular shape.

In a case where two or more batteries are stacked in the vertical direction and accommodated in the battery package 100, the battery farthest from the bottom surface of the first recessed portion 113 is the battery 200 having the protrusion 201. That is, the other batteries may be batteries that do not have the protrusion 201 as illustrated in FIG. 6.

As described above, in the battery module 500 according to Embodiment 1, since the elastic member 140 is located between the battery 200 and the first electrode 131, the elastic member 140 is not electrically connected to the lid body 160 or the like and is not electrically connected to the outside of the battery module 500. This suppresses discharge to the outside from members other than an external electrode such as the lid body 160, so that electric power can be efficiently extracted from the battery 200 via the first external electrode 134A and the second external electrode 134B.

The battery module 500 can fix the battery without using a conductive resin by accommodating the battery having the protrusion 201 in the battery package 100 including the elastic member 140 and the restriction portion 150. Thus, a battery module with high long-term reliability can be implemented. By providing the elastic member 140, a variation in the height of the battery or a variation in the depth of the recessed portion of the battery package can be absorbed.

In the battery module 500, the peripheral portion of the battery module 500 may be sealed with a sealing material such as a resin material. As a result, the battery package 100A or the battery module 500 can be mounted on the substrate such that neither the first external electrode 134B nor the second external electrode 134A of the battery package 100 illustrated in FIG. 3 are exposed to external environments. As a result, even if water enters the mounting substrate or even in a highly humid environment, an electrical short circuit does not occur between the first external electrode 134A and the second external electrode 134B, and the likelihood of electrical leakage from the battery module 500 can be reduced.

Alternatively, the first external electrode 134A and the second external electrode 134B may be disposed so as to be separated from the outer edge of the insulating substrate 110, and a seal pattern surrounding the first external electrode 134A and the second external electrode 134B may be disposed. The seal pattern may be made of a conductive material such as a solderable metal. The seal pattern may surround a periphery of the first external electrode 134A and a periphery of the second external electrode 134B.

By bonding the seal pattern and the pattern of the mounting substrate with solder, the first external electrode 134A and the second external electrode 134B located inside the seal pattern can be sealed. That is, the battery package 100 or the battery module 500 can be mounted on the substrate such that neither the first external electrode 134A nor the second external electrode 134B of the battery package 100 are exposed to external environments. Since the sealing by soldering can be performed simultaneously with the bonding of the first external electrode 134A and the second external electrode 134B with the electrodes of the mounting substrate by soldering.

### Variation 1 of Battery

FIG. 7 is a cross-sectional view of a battery module 500A including the battery package 100 and a battery 200A. In FIG. 7, the internal structure of the battery 200A is not illustrated. The battery 200A illustrated in FIG. 7 is a variation of the battery 200. As illustrated in FIG. 7, the protrusion 201A may be a plate-shaped member (metal plate) having conductivity and flexibility. The position of the protrusion 201A on the side surface 214c and the extending direction of the protrusion 201A are determined such that the end portion of the protrusion 201A abuts on the second electrode 132 in a state where the battery 200A is accommodated in the first recessed portion 113.

The protrusion 201A may be a member different from the positive electrode can 214 or the negative electrode can 215, and may be, for example, a plate-shaped member extending from the opening portion 214a. In this case, the protrusion 201A may be connected to the flank side surface 214c, for example, by brazing, soldering, or metal-welding. Therefore, the positive electrode can 214 and thus the battery 200A can be easily manufactured.

The protrusion 201A may be bonded so as to be separated from the side surface 214c from the negative electrode can 215 side toward the positive electrode can 214 side. That is, the protrusion 201A may have a hook shape. For example, the protrusion 201A may have an inclined shape or a stepped shape from the negative electrode can 215 side toward the positive electrode can 214 side in a side view. With such bonding, the protrusion 201A can increase the likelihood that the battery 200A can be smoothly inserted into the first recessed portion 113.

The protrusion 201A may be formed by, for example, punching out a claw-shaped portion together when the positive electrode can 214 is punched out from a metal plate, and then bending the claw-shaped portion with a die or the like. The protrusion 201A may be a portion of the positive electrode can 214 that extends outward from the opening portion 214a of the positive electrode can 214. As described above, the protrusion 201A may be a member integrally formed with the positive electrode can 214.

The protrusion 201A is elastic in the radial direction of the battery 200A. Therefore, when the battery 200A is inserted into the first recessed portion 113, the protrusion 201A is deformed so as to shrink in the radial direction due to being in contact with the insulating substrate 110. Therefore, when the protrusion 201A has the above-described resilience, the likelihood that the battery 200A can be smoothly inserted into the first recessed portion 113 can be increased. When the protrusion 201A abuts against the bottom surface of the second recessed portion 114, the movement of the battery 200 in the radial direction is also restricted, and the battery 200 can be fixed to the battery package 100. In a case where the second electrode 132 is also located on the bottom surface of the second recessed portion 114, the protrusion 201A abuts (is pressed against) the second electrode 132 due to the resilience in the radial direction, and thus a connection with a lower resistance can be realized.

### Variation 2 of Battery

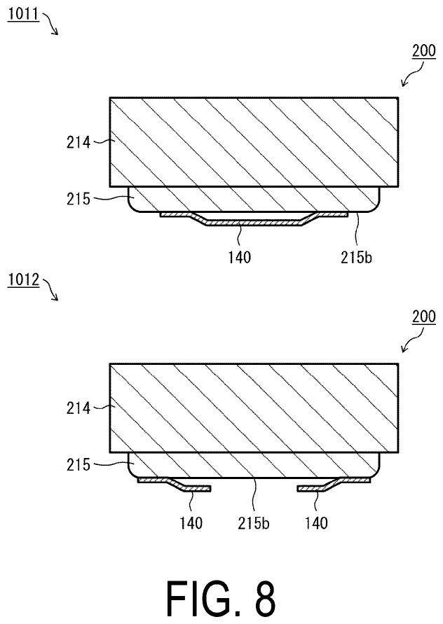

Reference signs 1011 and 1012 in FIG. 8 denote variations of the battery 200. In FIG. 8, the protrusion 201 located at the side surface 214c of each battery and the internal structure of the battery are not illustrated. Although the elastic member 140 and the battery 200 are separated from each other in the battery module 500 illustrated in FIGS. 2 to 5, the elastic member 140 may be fixed to the battery 200 as illustrated in FIG. 8. FIG. 8 illustrates the case where the elastic member 140 is fixed to the negative electrode can 215. The elastic member 140 may be fixed to the positive electrode can 214 depending on the orientation in which the battery 200 is accommodated in the battery package 100.

As indicated by the reference sign 1011 in FIG. 8, the battery 200 may include, as the elastic member 140, a single plate spring located so as to be convex in a direction away from the bottom 215b. As indicated by the reference sign 1012 in FIG. 8, the battery 200 may include, as the elastic member 140, a plurality of plate springs located so as to protrude in a direction away from the bottom 215b.

In addition, the battery 200 may include, as the elastic member 140, a plate spring (see FIG. 5) located so as to protrude in a direction toward the bottom 215b. The battery 200A may include a coil spring as the elastic member 140.

When two or more batteries are stacked in the vertical direction and accommodated in the battery package 100, the elastic member 140 is fixed to the bottom of the battery closest to the bottom surface of the first recessed portion 113.

The elastic member 140 is not limited to the examples illustrated in FIGS. 5 and 8, and may be, for example, a plate spring having another shape, a coil spring formed of a metal wire, a conductive rubber, or a conductive sponge. By using graphene mesosponge (GMS) as the conductive sponge, the elastic member 140 having excellent conductivity and durability can be implemented.

### Variation of Battery Package

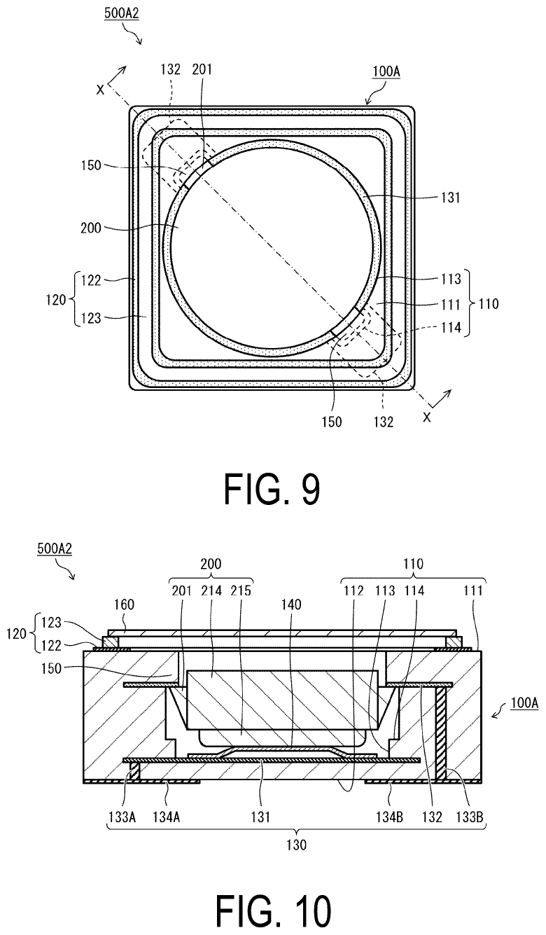

FIGS. 9 and 10 are diagrams illustrating a battery module 500A2 including the battery package 100A and the battery 200. FIG. 9 is a top view illustrating an example of the battery module 500A2 in a state where the lid body 160 is removed. FIG. 10 is a cross-sectional view taken along line X-X in FIG. 9. In FIG. 10, the internal structure of the battery 200 is not illustrated. The battery package 100A is different from the battery package 100 in that a frame portion 120 is provided.

As illustrated in FIG. 9, the battery package 100A includes a frame portion 120 surrounding the first recessed portion 113 on the first surface 111. This makes it possible to secure a distance between the upper surface of the battery 200 and the lid body 160. Therefore, the likelihood of contact between the battery 200 and the lid body 160 can be further reduced. Since the metal lid body 160 and the frame portion 120 can be bonded by seam welding or the like, the battery 200 can be hermetically sealed.

The frame portion 120 includes a frame-shaped metal film 122 and a metal frame body 123 bonded to the frame-shaped metal film 122. In this case, the lid body 160 may be made of metal, the metal frame body 123 may be bonded onto the frame-shaped metal film 122 with a brazing material, and the lid body 160 may be bonded (welded) to the metal frame body 123. As the welding, for example, seam welding, direct seam welding, laser welding, or electron beam welding is used. In particular, the seam welding is resistance welding via the metal frame body 123, and is advantageous in local heating of a bonding portion. Current is applied to the lid body 160 at the time of seam welding, but since the lid body 160 is not electrically connected to the battery 200, the battery 200 is not damaged by the current at the time of seam welding.

A nickel film may be formed on the surfaces of the frame-shaped metal film 122 and the metal frame body 123 by a plating method in order to improve bondability with a brazing material. As the metal frame body 123, a material having a small difference in thermal expansion from a ceramic may be used, and for example, an iron-nickel (Fe—Ni) alloy or an iron-nickel-cobalt (Fe—Ni—Co) alloy may be used.

As described above, since the frame portion 120 includes the frame-shaped metal film 122 and the metal frame body 123, the airtightness of the battery module 500A2 can be further increased while reducing the likelihood of contact between the battery 200 and the lid body 160.

### Second Embodiment

Another embodiment of the present disclosure will be described below. For convenience of description, members having the same functions as those of the members described in the above-described embodiment are denoted by the same reference signs, and description thereof is not repeated.

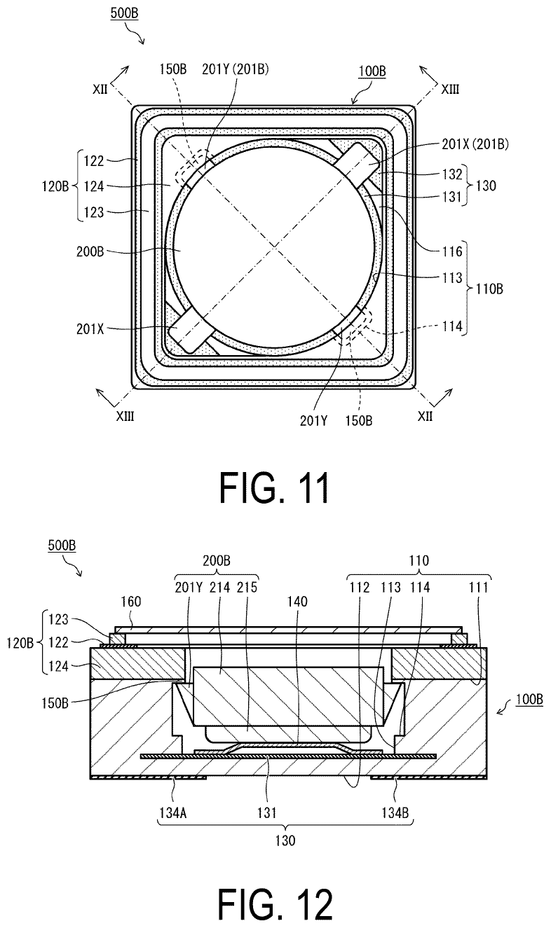

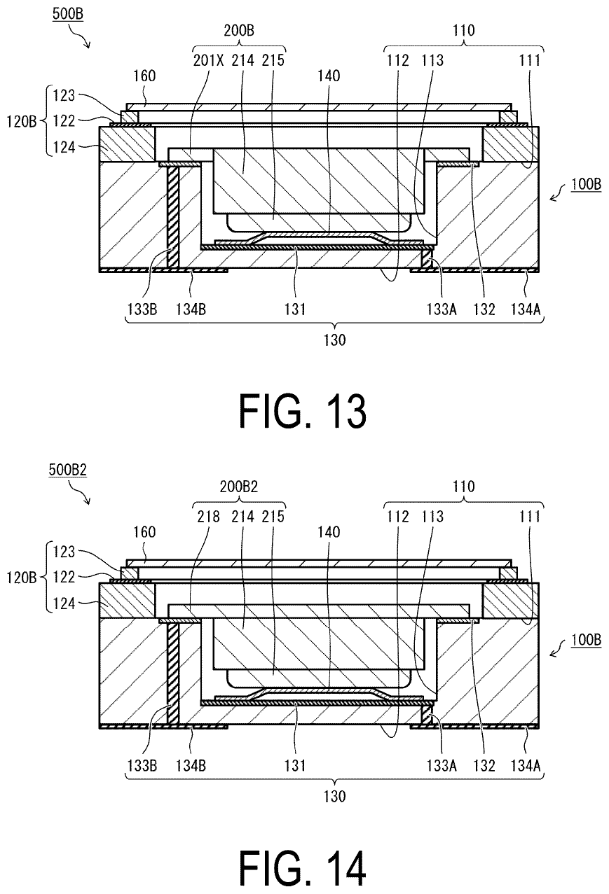

FIG. 11 is a top view of an exemplary battery module 500B according to Embodiment 2 in a state where the lid body 160 is removed. FIG. 12 is a cross-sectional view taken along line XII-XII in FIG. 11. FIG. 13 is a cross-sectional view taken along line XIII-XIII in FIG. 11. In FIGS. 12 and 13, the internal structure of the battery 200B is not illustrated.

As illustrated in FIGS. 11 to 13, the battery module 500B includes a battery package 100B and at least one battery 200B accommodated in the first recessed portion 113 of the battery package 100B.

The battery package 100B has the insulating substrate 110, and includes a frame portion 120B surrounding the first recessed portion 113 on the first surface 111 of the insulating substrate 110. The frame portion 120B includes an insulating frame body 124 located on the first surface 111, a frame-shaped metal film 122 located on the insulating frame body 124, and a metal frame body 123 bonded to the frame-shaped metal film 122. The lid body 160 is bonded to the metal frame body 123. The insulating frame body 124 is made of a ceramic material.

The battery package 100B is different from the insulating substrate 110 in that the second electrode 132 is located on the first surface 111 of the insulating substrate 110. As illustrated in FIG. 13, in Embodiment 2, the second electrode 132 is located between the frame portion 120B and the first recessed portion 113 on the first surface 111.

The shape of the insulating frame body 124 in a top view is a shape as long as the second electrode 132 located on the first surface 111 can be exposed. The insulating frame body 124 and the restriction portion 150B may overlap each other in the top perspective view. In other words, the insulating frame body 124 and the second protrusion portion 201Y of the battery 200B described later may overlap each other in the top perspective view. Since the insulating frame body 124 and the restriction portion 150B overlap each other, the strength of the restriction portion 150B can be improved.

The second recessed portion 114 may open in the first surface 111, and the lower surface of the insulating frame body 124 may be a ceiling surface of the second recessed portion 114. In this case, the restriction portion is a portion overlapping the second recessed portion 114 in the insulating frame body 124 in the top perspective view. The locking surface of the restriction portion is a portion exposed to the second recessed portion 114 on the lower surface of the insulating frame body 124. That is, the insulating frame body 124 has a protruding portion that protrudes from the inner surface of the second recessed portion 114, and the protruding portion can function as a restriction portion. Even if the second protrusion portion 201Y of the battery 200B abuts against the protruding portion of the insulating frame body 124, the battery 200B is not electrically connected to the lid body 160 because the insulating frame body 124 is interposed between the lid body 160 and the second protrusion portion 201Y.

As illustrated in FIG. 12, in a case where the restriction portion 150B, which is a part of the insulating substrate 110, is interposed between the insulating frame body 124 and the second protrusion portion 201Y, a metal frame may be used instead of the insulating frame body 124. The metal frame may have a protruding portion protruding from an upper surface of the metal frame. A protruding portion of a metal frame may function as the metal frame body 123. In this case, the battery package 100B need not include the frame-shaped metal film 122 and the metal frame body 123.

In the battery module 500B, the sum of the depth of the first recessed portion 113 and the height of the insulating frame body 124 is such a depth that the battery 200B is not in contact with the lid body 160 when the battery 200B is mounted on the battery package 100B. The state in which the battery 200B is mounted on the battery package 100B is a state in which the second protrusion portion 201Y is in contact with the restriction portion 150B and the elastic member 140 is compressed. The sum of the depth of first recessed portion 113 and the height of insulating frame body 124 may be greater than the height of the stack of the battery 200B accommodated in first recessed portion 113 and uncompressed elastic member 140.

The battery 200B may include, as the protrusion 201B, a first protrusion portion 201X in contact with the second electrode 132 and a second protrusion portion 201Y in contact with the restriction portion 150B.

In the battery module 500B, the restriction portion 150B is a portion of the insulating substrate 110B located between the second recessed portion 114 and the insulating frame body 124.

The positive electrode can 214 has the second protrusion portion 201Y at a position on the side surface 214c that comes into contact with at least a part of the restriction portion 150B, which will be described later, in a state where the battery 200B is accommodated in the first recessed portion 113. As a result, the movement of the battery 200B in the direction away from the bottom surface of the first recessed portion 113 is restricted by the elastic force of the elastic member 140.

In the present embodiment, the positive electrode can 214 has the second protrusion portion 201Y at positions facing each other on the side surface 214c. The number, size, and shape of the second protrusion portion 201Y and the position of the second protrusion portion 201Y on the side surface 214c may be determined in the same manner as the protrusion 201 of Embodiment 1.

In the battery package 100B, the restriction portion 150B need not include the second electrode 132. Therefore, unlike the protrusion 201 of Embodiment 1, the second protrusion portion 201Y need not have a function of being electrically connected to the second electrode 132.

The positive electrode can 214 also includes the first protrusion portion 201X at a position on the side surface 214c that is in contact with at least a portion of the second electrode 132 located on the first surface 111 in a state where the battery 200B is accommodated in the first recessed portion 113. The positive electrode can 214 may have only one first protrusion portion 201X or a plurality of first protrusion portions 201X on the side surface 214c. In the present embodiment, the positive electrode can 214 has the first protrusion portion 201X at positions facing each other in the uppermost portion of the side surface 214c.

The number, size, and shape of the first protrusion portion 201X may be changed as appropriate in accordance with the position, size, and shape of the second electrode 132. The number, size, and shape of the first protrusion portion 201X, and the position of the first protrusion portion 201X on the side surface 214c may be determined so as to reduce the likelihood that the battery 200B is inclined and a conduction failure occurs in a state where the battery 200B is accommodated in the first recessed portion 113. In the present embodiment, the first protrusion portion 201X has a plate shape.

The first protrusion portion 201X and the second protrusion portion 201Y may be alternately located along the outer periphery of the battery 200B so as to reduce the likelihood of occurrence of the conduction failure. In the present embodiment, the two first protrusion portions 201X and the two second protrusion portions 201Y are alternately located at intervals of 90° along the circumferential direction of the side surface 214c.

The first protrusion portion 201X and the second protrusion portion 201Y are alternately located at equal intervals along the circumferential direction of the side surface 214c. Accordingly, in a state where the battery 200B is mounted on the battery package 100B, the battery 200B is not inclined, and the battery 200B can be stably fixed to the battery package 100B. The likelihood that the battery 200B comes into contact with the lid body 160 due to the inclination or movement of the battery 200B can be reduced.

In the present embodiment, as illustrated in FIGS. 11 and 12, the two restriction portions 150B are opposed to each other with the first recessed portion 113 interposed therebetween. The two restriction portions 150B are located at opposite corners of the insulating substrate 110. Since the restriction portions 150B are disposed at positions facing each other across the first recessed portion 113, the posture of the battery 200B can be stabilized. Since the restriction portion 150B is located at the corner portion of the insulating substrate 110, a region in which the restriction portion 150B is provided can be secured and the size of the battery module 500B can be further reduced while reducing the likelihood of a decrease in the strength of the insulating substrate 110.

Since each of the two first protrusion portions 201X can be electrically connected to each of the two second electrodes 132, the likelihood of occurrence of a conduction failure between the first protrusion portion 201X and the second electrode 132 regardless of the flatness of the first surface 111 can be further reduced. In order to further reduce the likelihood of occurrence of a conduction failure, the battery package 100B may include three or more second electrodes 132, and the battery 200B may include three or more first protrusion portions 201X.

The first protrusion portion 201X and the second protrusion portion 201Y may be integrally molded with the positive electrode can 214. Alternatively, the first protrusion portion 201X and the second protrusion portion 201Y may be bonded to the upper surface of the positive electrode can 214 by, for example, brazing, soldering, or metal-welding. Instead of the second protrusion portion 201Y, the protrusion 201A illustrated in FIG. 7 may be used. The materials of the first protrusion portion 201X and the second protrusion portion 201Y may be the same as those of the positive electrode can 214, or may be any of the materials listed as the materials of the protrusion 201 in Embodiment 1.

As described above, the second protrusion portion 201Y need not have the function of being electrically connected to the second electrode 132. Therefore, the second protrusion portion 201Y need not have conductivity. In this case, the second protrusion portion 201Y may be made of, for example, rubber or plastic. The second protrusion portion 201Y may be bonded to the side surface 214c by, for example, resins.

When the lid body 160 is removed from the battery module 500B, the second electrode 132 is exposed on the upper surface of the battery package 100B. Therefore, the appearance of the second electrode 132 and the connection between the first protrusion portion 201X and the second electrode 132 for energization can be visually checked.

In the battery module 500B, the insulating substrate 110 includes the first recessed portion 113 and the second recessed portion 114, and the restriction portion 150B is an insulating substrate located between the second recessed portion 114 and the insulating frame body 124. However, the insulating substrate 110 need not have the second recessed portion 114. In this case, the insulating frame body 124 located above the second protrusion portion 201Y has a protruding portion protruding from the inner surface of the first recessed portion 113, and the protruding portion can function as the restriction portion 150B. That is, the restriction portion 150B may be a part of the insulating frame body 124.

### Variation of Battery

FIG. 14 is a cross-sectional view of a battery module 500B2 including the battery package 100B and a battery 200B2. In FIG. 14, the internal structure of the battery 200B2 is not illustrated. The battery 200B2 has a conductive member 218 on the upper surface (corresponding to the bottom 214b) of the positive electrode can 214. The conductive member 218 may be, for example, a plate-shaped member (metal plate) having conductivity. In a plan view of the battery 200B2, the portion of the conductive member 218 that protrudes from the side surface 214c may function as a first protrusion portion 201X.

The conductive member 218 may be bonded to the upper surface of the positive electrode can 214 by, for example, brazing, soldering, or metal-welding. Alternatively, the protrusion 201 may be integrally molded with the positive electrode can 214. The material of the conductive member 218 may be the same as that of the positive electrode can 214, or may be any of the materials listed as the material of the protrusion 201 in Embodiment 1.

### Embodiment 3

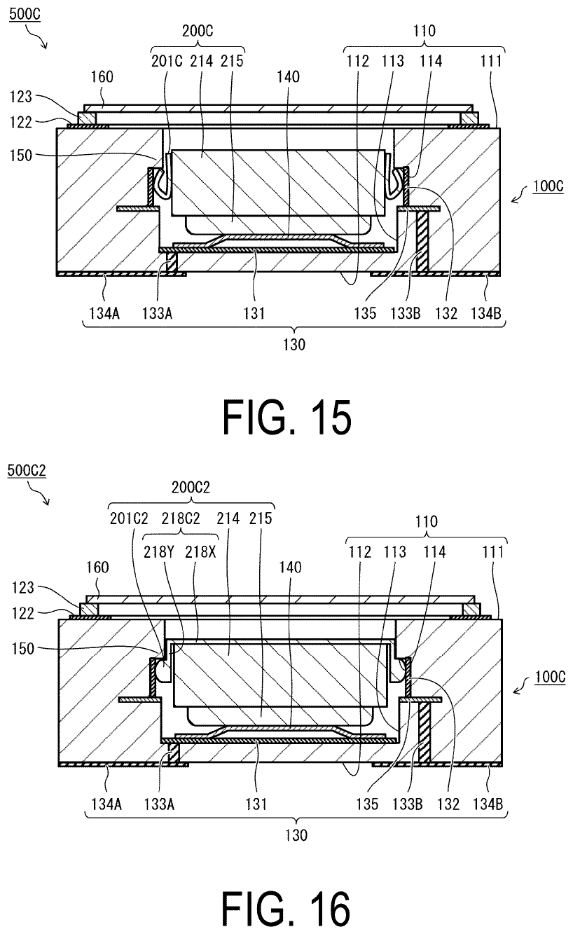

FIG. 15 is a cross-sectional view illustrating an example of a battery module 500C. In FIG. 15, the internal structure of a battery 200C is not illustrated. As illustrated in FIG. 15, the battery module 500C includes a battery package 100C and the battery 200C accommodated in the first recessed portion 113 of the battery package 100C.

As illustrated in FIG. 15, the battery 200C has a conductive protrusion 201C having an elastic force. The protrusion 201C is electrically connected to the second electrode 132 located on the inner surface of the second recessed portion 114 in a state where the battery 200C is accommodated in the first recessed portion 113. In the battery package 100C, the second electrode 132 is located on the inner surface (bottom surface) of the second recessed portion 114. The second electrode 132 is connected to the second connection wiring 133B via internal wiring 135 located inside the insulating substrate 110. The second electrode 132 may also be located on the upper surface (ceiling) of the second recessed portion 114. The protrusion 201C abuts against the restriction portion 150 by the elastic force of the elastic member 140.

The protrusion 201C is formed by bonding a part of a plate-shaped member (metal plate) having conductivity and flexibility to the side surface 214c and curving or bending a portion not bonded to the side surface 214c. The plate-shaped member may be bonded to the side surface 214c by, for example, brazing, soldering, or metal-welding.

Therefore, the battery 200C having the protrusion 201C can be manufactured only by bonding the plate-shaped member to the side surface 214c and bending the plate-shaped member. Therefore, the battery 200C can be easily manufactured.

The protrusion 201C having the curved portion or the bent portion is elastic in the radial direction of the battery 200C. Therefore, when the battery 200C is inserted into the first recessed portion 113, the protrusion 201C is deformed so as to shrink in the radial direction due to being in contact with the insulating substrate 110. Therefore, when the protrusion 201C has the above-described resilience, the likelihood that the battery 200C can be smoothly inserted into the first recessed portion 113 can be increased. When the protrusion 201C abuts against the bottom surface of the second recessed portion 114, the movement of the battery 200C in the radial direction is also restricted, and the battery 200C can be fixed to the battery package 100C. Due to the resilience in the radial direction, the protrusion 201C comes into contact with (is pressed against) the internal wiring 135 located on the bottom surface of the second recessed portion 114, and thus a connection with lower resistance can be realized.

### Variation of Battery

FIG. 16 is a cross-sectional view of a battery module 500C2 including the battery package 100C and a battery 200C2. In FIG. 16, the internal structure of the battery 200C2 is not illustrated. The battery 200C2 has a conductive member 218C.

The conductive member 218C2 includes a first portion 218X and a second portion 218Y. The first portion 218X is a portion of the conductive member 218C2 that extends at least in the radial direction of the battery 200C2. The second portion 218Y is a portion of the conductive member 218C2 that extends along the side surface 214c. A protrusion 201C2 is located at an end of the second portion 218Y.

The second portion 218Y is separated from the side surface 214c. Therefore, the second portion 218Y is elastic in the radial direction of the battery 200C2. Therefore, the second portion 218Y is deformed so as to contract in the radial direction, and the protrusion 201C2 is easily inserted into the first recessed portion 113.

The cross-sectional shape of the protrusion 201C2 along the radial direction of the battery 200C2 may be, for example, an arc shape. The cross-sectional shape is not limited thereto, and may be a shape in which the length along the radial direction of the battery 200C2 increases from the negative electrode can 215 side toward the positive electrode can 214 side. The shape of the cross section may be, for example, a right triangular shape, a trapezoidal shape, a stepped shape, or an arc shape. The shape of the cross section may be, for example, a rectangular shape.

The first portion 218X may be brazed, soldered, or metal-welded to the upper surface of the positive electrode can 214. The second portion 218Y may be formed by bending the conductive member 218C2. The protrusion 201C2 may be bonded to the end of the second portion 218Y, for example by being brazed, soldered or metal-welded thereto.

However, the protrusion 201C2 may be integrally molded with the conductive member 218C2. The protrusion 201C2 may be a curved portion or a bent portion formed by bending an end portion of the second portion 218Y. The conductive member 218C2 may be integrally molded with the positive electrode can 214.

### Fourth Embodiment

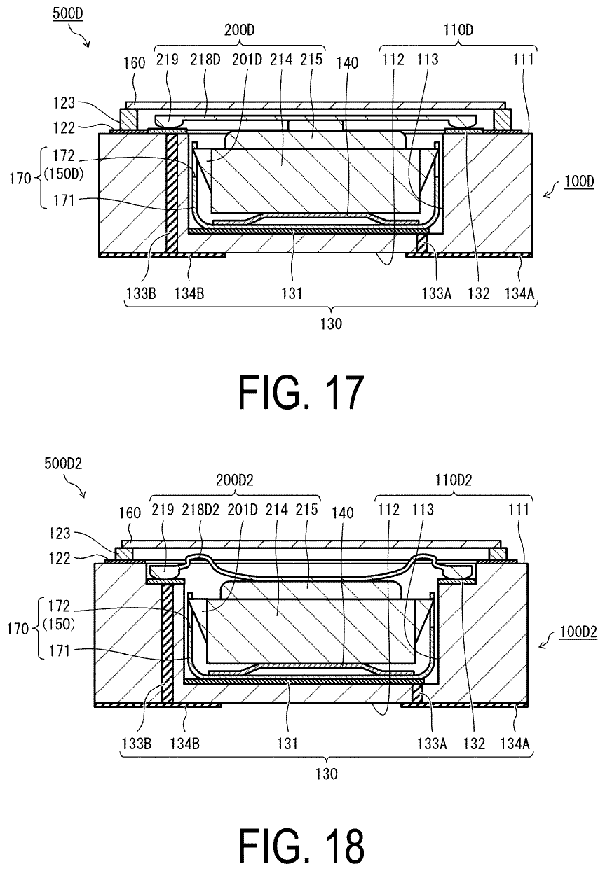

FIG. 17 is a cross-sectional view illustrating an example of a battery module 500D. In FIG. 17, the internal structure of a battery 200D is not illustrated. As illustrated in FIG. 17, the battery module 500D includes a battery package 100D and at least one battery 200D accommodated in the first recessed portion 113 of the battery package 100D.

In the battery module 500D, the battery 200D is accommodated such that the positive electrode can 214 is on the bottom surface side of the first recessed portion 113 and the negative electrode can 215 is on the opening side of the first recessed portion 113.

In the battery package 100D, the insulating substrate 110D is different from the insulating substrate 110 of Embodiment 1 in that it does not have the second recessed portion. On the other hand, the battery package 100D has a locking metal fitting 170 electrically connected to the first electrode 131. The locking metal fitting 170 includes a side plate 171 extending in a direction from the bottom surface of the first recessed portion 113 toward the opening of the first recessed portion 113 along the inner side surface of the first recessed portion 113. The side plate 171 has a restriction portion 150D. To be more specific, the side plate 171 has a through hole 172 whose edge portion abuts against a protrusion 201D, and the through hole 172 functions as the restriction portion 150D.

As illustrated in FIG. 17, the battery 200D has the protrusion 201D. The protrusion 201D has a cross-sectional shape along the radial direction of the battery 200D such that the length along the radial direction of the battery 200D increases from the positive electrode can 214 side toward the negative electrode can 215 side. In the present embodiment, the cross-sectional shape of the protrusion 201 is a right-angled triangle.

The battery 200D has a conductive member 218D extending from the upper surface (negative electrode can 215) of the battery 200D. The conductive member 218D may include, for example, a plate-shaped member (metal plate) having conductivity. The conductive member 218D may have flexibility. In this case, the conductive member 218D is elastic in the vertical direction.

In the present embodiment, the conductive member 218D has a pad 219 in contact with the second electrode 132 at the end of the conductive member 218D. Since the conductive member 218D is elastic, the pad 219 is pressed against the second electrode 132. This reduces the resistance in the connection between the conductive member 218D and the second electrode 132. However, the conductive member 218D may be a plate-shaped member that does not include the pad 219 as in a conductive member 218 illustrated in FIG. 14.

The conductive member 218D may be brazed, soldered or metal-welded to the upper surface of the battery 200D, for example. The pad 219 may be bonded to the end of the conductive member 218D by, for example, brazing, soldering, or metal-welding.

However, the pad 219 may be integrally molded with the conductive member 218D. The pad 219 may be a curved portion or a bent portion formed by bending an end portion of the conductive member 218D. The conductive member 218D may be integrally molded with the negative electrode can 215.

According to the configuration of the battery module 500D, the positive electrode of the battery 200D can be connected to the first electrode 131 and the first external electrode 134A, and the negative electrode can be connected to the second electrode 132 and the second external electrode 134B.

FIG. 18 is a cross-sectional view of a battery module 500D2 including a battery package 100D2 and a battery 200D2. In FIG. 18, the internal structure of the battery 200D2 is not illustrated.

The battery 200D2 has a conductive member 218D2. The conductive member 218D2 is different from the conductive member 218D in FIG. 17 in that a plate-shaped member (metal plate) having conductivity and flexibility is bent in the vertical direction.

The conductive member 218D2 is elastic in the vertical direction. This makes it possible to absorb manufacturing errors such as variations in the height direction of the battery 200D2 and variations in the depth of the first recessed portion 113, and expansion and shrinkage of the battery 200D2. Accordingly, the conduction between the second electrode 132 and the conductive member 218D2 can be stabilized. Since the conductive member 218D2 has a portion bent in the vertical direction, the conductive member 218D is more easily deformed than the conductive member center. As illustrated in FIG. 18, the battery package 100D2 may have a step portion on the first surface 111 of the insulating substrate 110D2 so as to accommodate the bent portion of the conductive member 218D2. In this case, the second electrode 132 may be formed on an upper surface of the step portion.

In the present embodiment, the conductive member 218D2 has the pad 219 in contact with the second electrode 132 at the end of the conductive member 218D2. Since the conductive member 218D2 is elastic, the pad 219 is pressed against the second electrode 132. This reduces the resistance in the connection between the conductive member 218D2 and the second electrode 132. However, the conductive member 218D2 need not include the pad 219.

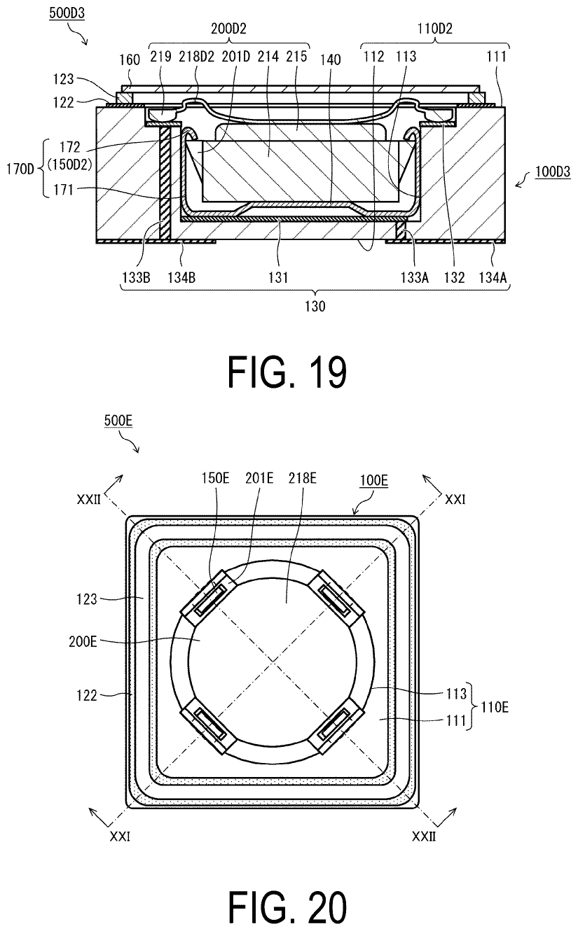

FIG. 19 is a cross-sectional view of a battery module 500D3 including a battery package 100D3 and a battery 200D2. In FIG. 19, the internal structure of the battery 200D2 is not illustrated.

The battery package 100D3 has a locking metal fitting 170D. The locking metal fitting 170D includes a side plate 171 extending in a direction from the bottom surface of the first recessed portion 113 toward the opening of the first recessed portion 113 along the inner side surface of the first recessed portion 113. The side plate 171 has a restriction portion 150D2. To be more specific, the side plate 171 has a bent portion 173 at an end portion of the side plate 171, and the bent portion 173 functions as the restriction portion 150D2. The bent portion 173 is bent from the extending direction of the side plate 171 toward the battery 200D2. Accordingly, the protrusion 201D of the battery 200D2 may abut against the restriction portion 150D2 by the elastic force of the elastic member 140.

### Fifth Embodiment

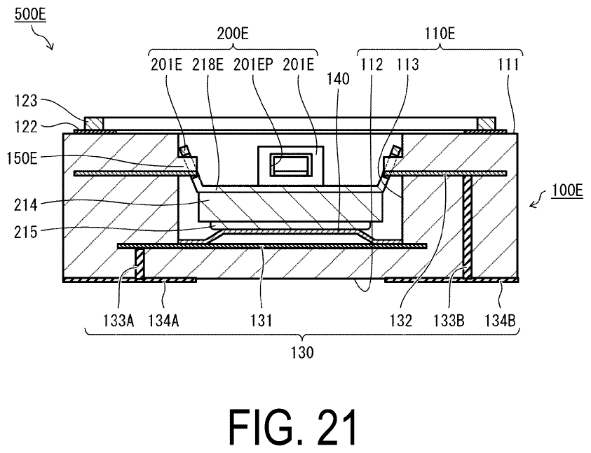

FIG. 20 is a top view illustrating an example of a battery module 500E in a state where the lid body 160 is removed. FIG. 21 is a cross-sectional view taken along line XXII-XXII in FIG. 20. In FIG. 21, the internal structure of the battery 200E is not illustrated.

As illustrated in FIGS. 20 and 21, the battery module 500E includes a battery package 100E and a battery 200E accommodated in the first recessed portion 113 of the battery package 100E.

The battery 200E has a conductive member 218E on the upper surface of the positive electrode can 214. The conductive member 218E may be, for example, a plate-shaped member (metal plate) having conductivity. In a plan view of the battery 200E, the conductive member 218E has a protrusion 201E protruding from the side surface 214c in a top view.

As illustrated in FIG. 21, the protrusion 201E protrudes upward or obliquely upward from the positive electrode can 214. The battery 200E has four protrusions 201E at equal intervals along the peripheral edge of the battery 200E. The protrusion 201E has a through hole 201EP.

The insulating substrate 110E has a restriction portion 150E that protrudes from the inner wall surface of the first recessed portion 113 toward the central portion of the first recessed portion 113. That is, the restriction portion 150E is a protruding portion protruding from the inner side surface of the first recessed portion 113. In the battery package 100E, the second electrode 132 is located on the lower surface of the restriction portion 150E. When the restriction portion 150E is engaged with the through hole 201E of the protrusion 201EP, the battery 200E can be electrically connected to the second electrode 132 located on the lower surface of the restriction portion 150E. The second electrode 132 may also be located on the upper surface of the restriction portion 150E, which is a part of the inner side surface of the insulating substrate 110E. In this case, the protrusion 201E is electrically connected to the second electrode 132 located on the upper surface of the restriction portion 150E by the force of the protrusion 201E spreading laterally. Engagement of the restriction portion 150E with the through hole 201EP limits movement of the battery 200E in a direction away from the bottom surface of the first recessed portion 113. With the through hole 201EP, the battery 200E can be held more stably in the first recessed portion 113. By adjusting the position of the through hole 201EP, the position of the battery 200E in the first recessed portion 113 can be adjusted.

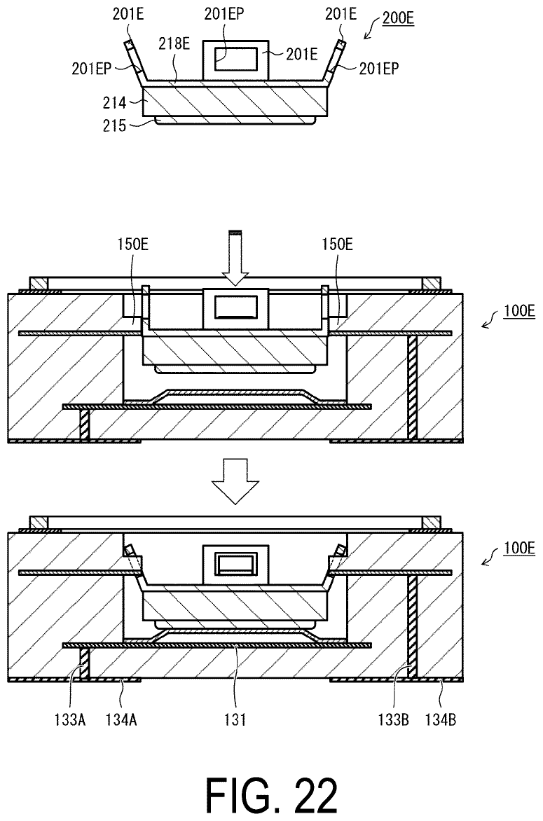

FIG. 22 is a diagram illustrating a state when the battery 200E is accommodated in the battery package 100E. In FIG. 22, the internal structure of the battery 200E is not illustrated. As illustrated in FIG. 22, the battery 200E can be accommodated in and fixed to the battery package 100E by elastic deformation of the conductive member 218E.

In Embodiment 5, an example in which the protrusion 201E has the through hole 201EP is illustrated, but the protrusion 201E need not have the through hole 201EP. In this case, the upper end of the protrusion 201E and the lower surface of the restriction portion 150E come into contact with each other, so that the battery 200E and the second electrode 132 can be electrically connected to each other, and the battery 200E is limited from moving in a direction away from the bottom surface of the first recessed portion 113.

### Embodiment 6

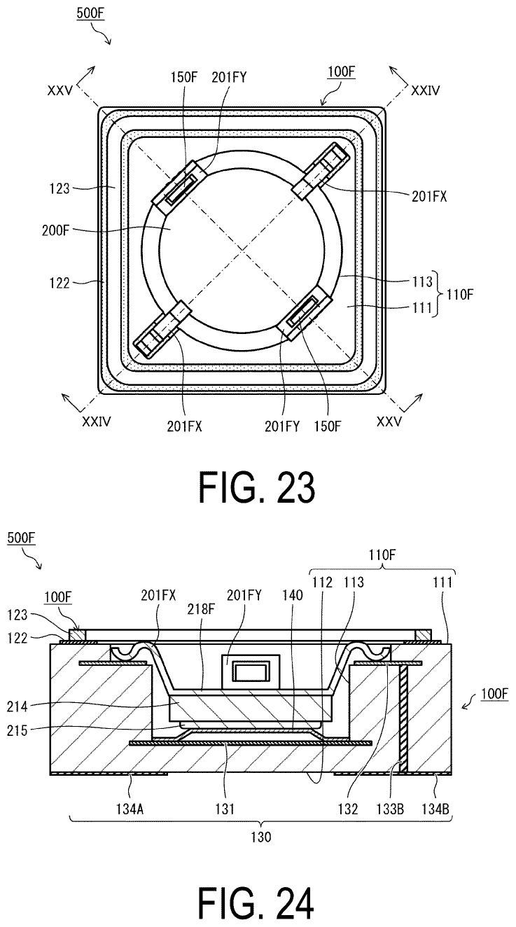

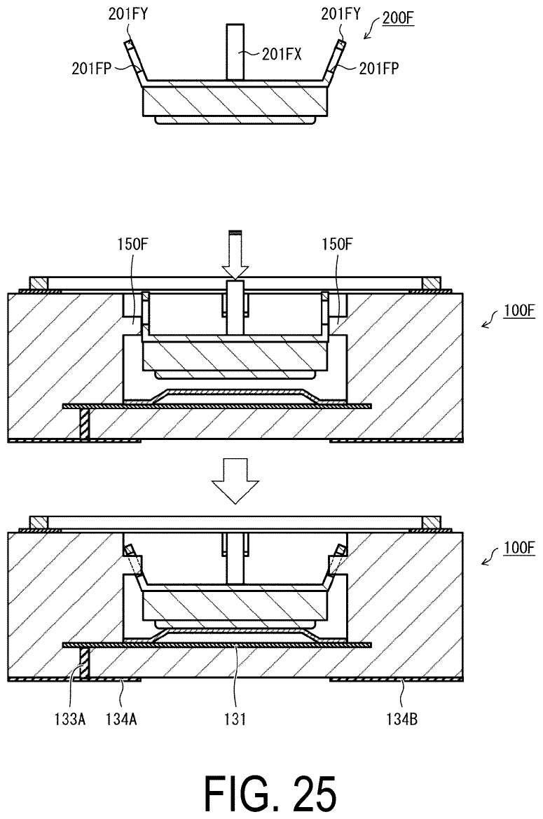

FIG. 23 is a top view illustrating an example of the battery module 500F in a state where the lid body 160 is removed. FIG. 24 is a cross-sectional view taken along line XXIV-XXIV in FIG. 23. FIG. 25 is a diagram illustrating a state when the battery 200F is accommodated in the battery package 100F. The lowermost figure in FIG. 25 is a cross-sectional view taken along line XXV-XXV in FIG. 23. In FIGS. 24 and 25, the internal structure of the battery 200F is not illustrated.

As illustrated in FIGS. 23 and 24, a battery module 500F includes a battery package 100F and a battery 200F accommodated in the first recessed portion 113 of the battery package 100F. The battery package 100F includes an insulating substrate 110F.

The insulating substrate 110F has a restriction portion 150F that protrudes from the inner wall surface of the first recessed portion 113 toward the central portion of the first recessed portion 113. The insulating substrate 110F has a step portion on the first surface 111. The second electrode 132 is located on the upper surface of the step portion.

The battery 200F includes a conductive member 218F located on the upper surface of the positive electrode can 214. The conductive member 218F may be, for example, a plate-shaped member (metal plate) having conductivity. In a plan view of the battery 200F, the conductive member 218F includes a first protrusion portion 201FX and a second protrusion portion 201FY that protrude from the side surface 214c in a top view.

As illustrated in FIG. 24, the first protrusion portion 201FX may extend upward or obliquely upward from the positive electrode can 214. The portion protruding from the positive electrode can 214 has a plurality of curved portions that are curved in different directions in the vertical direction. The first protrusion portion 201FX is electrically connected to the second electrode 132. Since the first protrusion portion 201FX has a plurality of curved portions, the first protrusion portion 201FX is elastic in the vertical direction and can stabilize conduction with the second electrode 132.

The second protrusion portion 201FY has a through hole 201FP. When the restriction portion 150F engages with the through hole 201FP of the second protrusion portion 201FY, the battery 200F is limited from moving in a direction away from the bottom surface of the first recessed portion 113.

In the present embodiment, the two first protrusion portions 201X and the two second protrusion portions 201Y are alternately located at intervals of 90° along the circumferential direction of the side surface 214c. As illustrated in FIG. 25, the battery 200F can be accommodated in and fixed to the battery package 100F by elastic deformation of the conductive member 218F.

### Embodiment 7

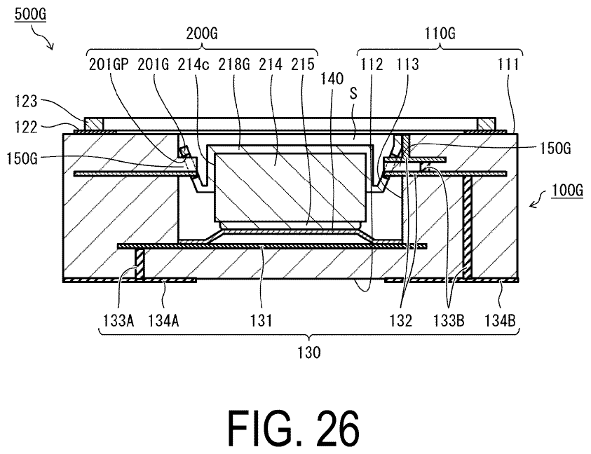

FIG. 26 is a cross-sectional view illustrating an example of the battery module 500G in a state where the lid body 160 is removed. In FIG. 26, the internal structure of the battery 200G is not illustrated.

As illustrated in FIG. 26, a battery module 500G includes a battery package 100G and a battery 200G accommodated in the first recessed portion 113 of the battery package 100G.

The battery 200G has a conductive member 218G on the upper surface of the positive electrode can 214. The battery 200G includes a protrusion 201G that extends downward from the conductive member 218G along the side surface 214c of the battery 200G and protrudes upward or obliquely upward.

Alternatively, similarly to the protrusion 201A (see FIG. 7), the protrusion 201G may protrude upward or obliquely upward from the side surface 214c of the battery 200G. The protrusion 201G has a through hole 201GP.

An insulating substrate 110G of the battery package 100G has a plurality of restriction portions 150G protruding from the inner wall surface of the first recessed portion 113 toward the central portion of the first recessed portion 113. In the battery package 100G, the second electrode 132 is located on the lower surface of the restriction portion 150G.

When the restriction portion 150G is engaged with the through hole 201GP of the protrusion 201G, the battery 200G can be electrically connected to the second electrode 132 located on the lower surface of the restriction portion 150G. In the battery package 100G, the protrusion 201G protrudes upward from the side surface 214c of the battery 200G, and the through hole 201GP of the protrusion 201G engages with the restriction portion 150G on the side of the battery 200G, so that the space S between the battery 200G and the lid body 160 can be reduced. This makes it possible to increase the energy density of the battery module 500G.

As illustrated in FIG. 26, in the insulating substrate 110G, the second electrode 132 may also be located on the upper surface of at least one restriction portion 150G and the inner side surface of the insulating substrate 110E above the restriction portion 150G. With this configuration, the contact area between the protrusion 201G and the second electrodes is increased, so that the connection resistance between the battery 200G and the second electrode 132 is reduced and the power extraction rate can be increased.

### SUMMARY

(1) A battery module according to a first aspect of the present disclosure includes: a battery including upper and lower electrodes and at least one protrusion; and a package including: an insulating substrate including a first surface, a second surface located on a side opposite to the first surface, and a first recessed portion that opens to the first surface and is configured to accommodate the battery; a first external electrode located on the second surface; a second external electrode located on the second surface; a first electrode located on a bottom surface of the first recessed portion and electrically connected to the battery and the first external electrode; a second electrode electrically connected to the battery and the second external electrode; an elastic member disposed on the first electrode and configured to electrically connect the battery and the first electrode; and a package including a restriction portion configured to come into contact with the at least one protrusion to restrict the battery from moving in a direction away from the bottom surface of the first recessed portion due to an elastic force of the elastic member.
(2) A battery module according to a second aspect of the present disclosure is the battery module according to the first aspect, in which the second electrode is located in the restriction portion.
(3) A battery module according to a third aspect of the present disclosure is the battery module according to the first or second aspect, in which the at least one protrusion protrudes laterally from the battery.
(4) A battery module according to a fourth aspect of the present disclosure is the battery module according to the first or second aspect, in which the at least one protrusion protrudes upward from an upper surface of the battery.
(5) A battery module according to a fifth aspect of the present disclosure is the battery module according to any one of the first to fourth aspects, in which the insulating substrate includes a second recessed portion that opens to an inner side surface of the first recessed portion, and an insulating substrate located between the second recessed portion and the first surface is the restriction portion.
(6) A battery module according to a sixth aspect of the present disclosure is the battery module according to the fifth aspect, in which the second electrode is located on an inner surface of the second recessed portion.
(7) A battery module according to a seventh aspect of the present disclosure is the battery module according to any one of the first to fourth aspects, in which the insulating substrate includes a protruding portion protruding from an inner side surface of the first recessed portion, and the protruding portion is the restriction portion.
(8) A battery module according to an eighth aspect of the present disclosure is the battery module according to the seventh aspect, in which the second electrode is located on the protruding portion.
(9) A battery module according to a ninth aspect of the present disclosure is the battery module according to any one of the first to eighth aspects, in which the battery includes, as the at least one protrusion: a first protrusion portion electrically connected to the second electrode; and a second protrusion portion that abuts against the restriction portion, the package includes a frame portion surrounding the recessed portion on the first surface, and the second electrode is located between the frame portion and the recessed portion on the first surface.
(10) A battery module according to a tenth aspect of the present disclosure is the battery module according to the ninth aspect, in which the first protrusion portion and the second protrusion portion are alternately located along an outer periphery of the battery.
(11) A battery module according to an eleventh aspect of the present disclosure is the battery module according to any one of the first to tenth aspects, in which the elastic member is a metal spring.
(12) A battery module according to a twelfth aspect of the present disclosure is the battery module according to the first aspect, in which the package includes a locking metal fitting electrically connected to the first electrode, the locking metal fitting includes a side plate extending along an inner side surface of the recessed portion in a direction from a bottom surface of the recessed portion toward an opening of the recessed portion, and the side plate includes a restriction portion.
(13) A battery module according to a thirteenth aspect of the present disclosure is the battery module according to any one of the first to twelfth aspects, further including a lid body that closes the recessed portion and is insulated from the battery.
(14) A battery module according to a fourteenth aspect of the present disclosure is the battery module according to any one of the first to thirteenth aspects, further including a frame portion surrounding the first recessed portion on the first surface.
(15) A battery module according to a fifteenth aspect of the present disclosure is the battery module according to the fourteenth aspect, in which the frame portion includes a frame-shaped metal film and a metal frame body bonded to the frame-shaped metal film.
(16) A battery module according to a sixteenth aspect of the present disclosure is the battery module according to the fifteenth aspect in which the frame portion includes an insulating frame body between the frame-shaped metal film and the first surface.

### SUPPLEMENTARY NOTE

The invention according to the present disclosure has been described above based on various drawings and example. However, the invention according to the present disclosure is not limited to each embodiment described above. That is, the invention according to the present disclosure can be modified in various ways within the scope described in the present disclosure, and embodiments obtained by combining technical means disclosed in the different embodiments as appropriate are also included in the technical scope of the invention according to the present disclosure. In other words, it should be noted that a person skilled in the art can easily make various variations or modifications based on the present disclosure. It should also be noted that these variations or modifications are included in the scope of the present disclosure.

### REFERENCE SIGNS

500, 500A, 500A2, 500B, 500B2, 500C, 500C2, 500D, 500D2, 500D3, 500E, 500F, 500G Battery module
100, 100A, 100B, 100C, 100D, 100D2, 100D3, 100E, 100F, 100G Battery package
110, 110B, 110D, 110D2, 110E, 110F, 110G Insulating substrate
113 First recessed portion
114 Second recessed portion
120, 120B Frame portion
122 Frame-shaped metal film
123 Metal frame body
124 Insulating frame body
130 Wiring conductor
131 First electrode
132 Second electrode
134A First external electrode
134B Second external electrode
140 Elastic member
150, 150B, 150D, 150D2, 150E, 150F, 150G Restriction portion
160 Lid body
170, 170d Locking Metal Fitting
171 Side plate
200, 200A, 200B, 200B2, 200C, 200C2, 200D, 200D2, 200E, 200F, 200G Battery
201, 201A, 201B, 201C, 201C2, 201D, 201E, 201G Protrusion
201FX, 201X First protrusion portion
201FY, 201Y Second protrusion portion

1. A battery package:
that accommodates a battery comprising upper and lower electrodes and at least one protrusion,
the battery package comprising:
an insulating substrate comprising a first surface, a second surface located on a side opposite to the first surface, and a first recessed portion that opens to the first surface and is configured to accommodate the battery;
a first external electrode located on the second surface;
a second external electrode located on the second surface;
a first electrode located on a bottom surface of the first recessed portion and electrically connected to the battery and the first external electrode;
a second electrode electrically connected to the battery and the second external electrode;
an elastic member disposed on the first electrode and configured to electrically connect the battery and the first electrode; and
a restriction portion configured to come into contact with the at least one protrusion to restrict the battery from moving in a direction away from the bottom surface of the first recessed portion due to an elastic force of the elastic member.

2. The battery package according to claim 1, wherein
the second electrode is located in the restriction portion.

3.-4. (canceled)

5. The battery package according to claim 1, wherein
the insulating substrate comprises a second recessed portion that opens to an inner side surface of the first recessed portion, and
an insulating substrate located between the second recessed portion and the first surface is the restriction portion.

6. The battery package according to claim 5, wherein
the second electrode is located on an inner surface of the second recessed portion.

7. The battery package according to claim 1, wherein
the insulating substrate comprises a protruding portion protruding from an inner side surface of the first recessed portion, and
the protruding portion is the restriction portion.

8. The battery package according to claim 5, wherein
the second electrode is located on the protruding portion.

9.-10. (canceled)

11. The battery package according to claim 1, wherein
the elastic member is a spring made of metal.

12. The battery module package according to claim 1, wherein
the battery package comprises a locking metal fitting electrically connected to the first electrode,
the locking metal fitting comprises a side plate extending along an inner side surface of the first recessed portion in a direction from a bottom surface of the first recessed portion toward an opening of the first recessed portion, and
the side plate comprises a restriction portion.

13. The battery package according to claim 1, further comprising:
a lid body that closes the first recessed portion and is insulated from the battery.

14. The battery package according to claim 1, further comprising:
a frame portion surrounding the first recessed portion on the first surface.

15. The battery package according to claim 10, wherein
the frame portion comprises a frame-shaped metal film and a metal frame body bonded to the frame-shaped metal film.

16. The battery package according to claim 11, wherein
the frame portion comprises an insulating frame body between the frame-shaped metal film and the first surface.

17. The battery package according to claim 10, further comprising a lid body that closes the recessed portion and is insulated from the battery.

18. A battery module comprising:
a battery package according to claim 1; and
the battery accommodated in the battery package.

19. The battery module according to claim 14, wherein
the battery comprises, as the at least one protrusion:
a first protrusion portion electrically connected to the second electrode; and
a second protrusion portion that abuts against the restriction portion,
the package comprises a frame portion surrounding the first recessed portion on the first surface, and
the second electrode is located between the frame portion and the first recessed portion on the first surface.

20. The battery module according to claim 15, wherein
the first protrusion portion and the second protrusion portion are alternately located along an outer circumference of the battery.

21. The battery module according to claim 14, wherein
the at least one protrusion protrudes laterally from the battery.

22. The battery module according to claim 14, wherein
the at least one protrusion protrudes upward from an upper surface of the battery.
